(19) United States
(12) Patent Application Publication
(10) Pub. No.: US 2005/0135113 A1
(43) Pub. Date: Jun. 23, 2005

(54) Optical projection device of a colored lighting module

(75) Inventors: Bily Wang, Hsin Chu City (TW); Jonnie Chuang, Pan Chiao City (TW); Shih-Yu Wu, Pan Chiao City (TW)

Correspondence Address: TROXELL LAW OFFICE PLLC, SUITE 1404, 5205 LEESBURG PIKE, FALLS CHURCH, VA, 22041, US

(73) Assignee: Harvatek Corporation

(21) Appl. No.: 10/737,904

(22) Filed: Dec. 18, 2003

(51) Int. Cl. F21V 7/04

(52) U.S. Cl. 362/561; 362/800; 362/11; 362/16; 362/33; 362/240; 362/97

(57) ABSTRACT

An optical projection device with a colored lighting module has a mask, a lighting module and a lens. The mask has a receiving cavity formed therein, a first opening and a second opening relating to the first opening, the first opening and the second opening both communicating with the receiving cavity and respectively formed on two opposing sides of the mask, and the mask has a reflection layer disposed in an interior surface thereof. The lighting module and the lens are respectively disposed by the first and second openings of the mask.

### BACKGROUND OF THE INVENTION

1. Field of the Invention

The present invention relates to an optical projection device with a colored lighting module, in which the colored lighting module is disposed in an optical mask for colored lighting and then covers a lens for converging or diffusing.

2. Background of the Invention

A conventional light emission diode (LED) is one kind of electronic component produced by single-crystal semiconductor materials. Red and green LEDs are the most common at present.

Because of high reliability thereof, and the easy on/off control thereof, applications for the conventional LED have broadened and it has gradually supplanted the conventional lamp because of its ability to show something by a plurality of light segments. However, the conventional LED with light, which cannot reach far, has some restrictions in use.

### SUMMARY OF INVENTION

The primary object of the invention is therefore to specify an optical projection device with a colored lighting module, in which a plurality of LEDs is arranged into a mask and subsequently covered with a lens, to allow the colored lighting module to emit colored light and use the lens to converge or diffuse the light to reach far or near.

According to the invention, this object is achieved by an optical projection device with a colored lighting module including a mask, a lighting module and a lens. The mask has a receiving cavity formed therein. A first opening and a second opening relating to the first opening are formed in the mask, the first opening and the second opening both communicating with the receiving cavity and respectively formed in two opposing sides of the mask, and the mask includes a reflection layer disposed in an interior surface thereof. The lighting module and the lens are respectively disposed by the first and second opening of the mask.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

These and other features, aspects, and advantages of the present invention will become better understood with regard to the following description, appended claims, and accompanying drawings where:

FIG. 1 is a cross-sectional view of the present invention optical projection device with a colored lighting module;

FIG. 2 is an exploded profile of the present invention optical projection device with a colored lighting module; and

FIG. 3 is an exploded profile according to another embodiment of the present invention optical projection device with a colored lighting module.

### DETAILED DESCRIPTION OF THE EMBODIMENTS

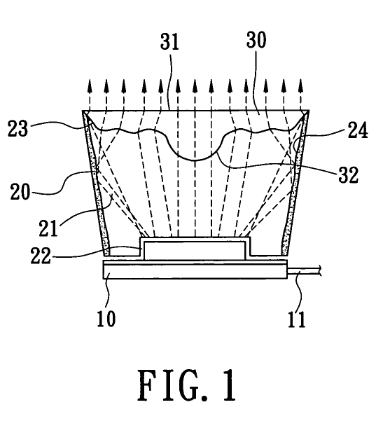

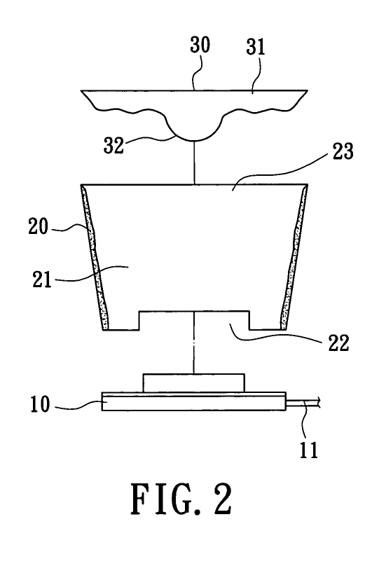

With respect to FIG. 1 and FIG. 2, the present invention provides an optical projection device of a colored lighting module, including a colored lighting module 10, a mask 20 and a lens 30. The colored lighting module 10 includes a plurality of LEDs, such as red, green, or blue LEDs. The colored lighting module 10 also includes a plurality of pins 11, respectively electrically connecting an anode and a cathode for electrically driving chips (not shown), which are disposed in the colored lighting module 10, to provide light.

The mask 20 is made of a plastic or similar material, and is a hollow housing in conical or other shape, according to practical requirements. The mask 20 has a receiving cavity 21 formed therein, a first opening 22 and a second opening 23 relating to the first opening 22. The first opening 22 and the second opening 23 both communicate with the receiving cavity 21 and are respectively formed on two opposing sides of the mask 20, which are a lower side and an upper side of the mask 20. The mask 20 includes a reflection layer 24, which is electroplated or otherwise processed, disposed on an interior surface thereof. The reflection layer 24 is highly reflective. The colored lighting module 10 is arranged by the first opening 22 of the lower side of the mask 20 and is, for example, clamped, stuck or screwed to the mask 20.

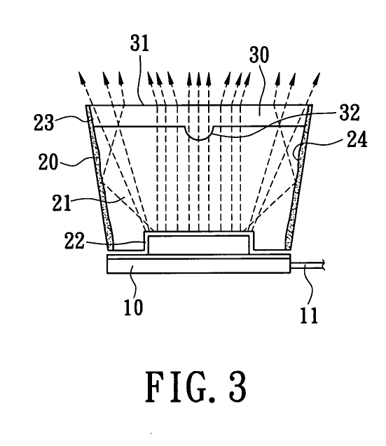

The lens 30 is made of a transparent material, and includes a first face 31 and a second face 32 opposite the first face 31. The first face 31 and the second face 32 each can be flat, concave, or convex to provide a concave or convex lens formed thereby for converging and diffusing the light emitted from the colored lighting module. The first face 31 and the second face 32 can be shaped otherwise, as meets practical requirements, as illustrated in FIG. 3. The lens 30 is arranged by the second opening 23 of the upper side of the mask 20, and is, for example, clamped, stuck or screwed to the mask 20. The lens 30 is opposite and disposed over the colored lighting module 10.

Referring to FIG. 1, the colored lighting module 10 emits light. Part of the light is transmitted by the lens 30 and is converged outwardly, and the other part of the light is reflected by the reflection layer 24 first and transmitted to the lens 30 to be converged outwardly later.

The colored lighting module 10 arranged in the mask 20 with a lens 30 subsequently covering thereon generates colored light first and then converges the light for projection over a long distance. Accordingly, the present invention is adopted for decorative purposes as well. Application of various kinds of lenses 30 allows the light to be diffused for projection over short distances, instead.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. An optical projection device with a colored lighting module, comprising:
a mask having a receiving cavity formed therein, a first opening and a second opening relating to the first opening, the first opening and the second opening both communicating with the receiving cavity and respectively formed on two opposing sides of the mask, and the mask including a reflection layer disposed in an interior surface thereof;
a colored lighting module arranged by the first opening; and
a lens arranged by the second opening.

2. The optical projection device with a colored lighting module claimed as claim 1, wherein the colored lighting module includes a plurality of LEDs.

3. The optical projection device with a colored lighting module claimed as claim 1, wherein the colored lighting module connects to the mask.

4. The optical projection device with a colored lighting module claimed as claim 1, wherein the lens connects to the mask.
